(19) United States
(12) Patent Application Publication
(10) Pub. No.: US 2024/0174519 A1
(43) Pub. Date: May 30, 2024

(54) Oxidation Resistant Coating on Carbonaceous Surface

(71) Applicant: CORNING INCORPORATED, Corning, NY (US)

(72) Inventor: Benedict Yorke Johnson, Horseheads, NY (US)

(21) Appl. No.: 18/383,530

(22) Filed: Oct. 25, 2023

Related U.S. Application Data
(60) Provisional application No. 63/466,734, filed on May 16, 2023.
(60) Provisional application No. 63/428,775, filed on Nov. 30, 2022.

(51) Int. Cl. C01B 32/21

(52) U.S. Cl. CPC C01B 32/21; C01P 2004/84

(57) ABSTRACT

Methods for providing an oxidation resistant coating on a carbonaceous surface, including steps of applying a phosphate-borate solution to form a first layer on the carbonaceous surface, applying a CeO₂—Al₂O₃ solution onto the first layer to form a second layer, and applying the phosphate-borate solution to an outermost surface portion of the second layer. A substrate comprising a carbonaceous surface, such as graphite, wherein oxidation resistant protective coating is disposed on the carbonaceous surface, the oxidation resistant protective coating being comprised of a first layer comprised of a phosphate-borate material, a second layer comprised of CeO₂—Al₂O₃, and additional phosphate-borate material disposed on and/or in an outermost surface portion of the second layer.

### CROSS REFERENCE TO RELATED APPLICATION

This application claims the benefit of priority under 35 U.S.C. § 119 of U.S. Provisional Application Ser. No. 63/466,734 filed on May 16, 2023, and U.S. Provisional Application Ser. No. 63/428,775, filed on Nov. 30, 2022, the content of which is relied upon and incorporated herein by reference in their entireties.

### BACKGROUND

### Field

The present specification relates to methods of protection of carbonaceous surfaces of substrates against erosion and/or oxidation by a protective coating, and the resulting substrates with such protective coating.

### Technical Background

Various graphite products are widely used in the chemical and metallurgical industries for high-temperature applications, for example crucibles that are used in the melting of many metals and glass production, for electrodes in electro-arc furnaces, and others. Graphite crucibles or molds, for example, exhibit good mechanical strength and excellent thermal stability under the temperature conditions encountered. Although pure graphite is one of the most inert and least reactive materials known at high temperatures, a major deficiency to the use of graphite and other carbonaceous articles is that they rapidly oxidize and erode at temperatures above about 500° C. as the carbon reacts with oxygen to form carbon monoxide CO and/or carbon dioxide CO₂, wherein the graphite product deteriorates and loses its shape and mechanical strength. Crucibles can thus become thinned and periodically must be replaced. Graphite rods, when used as electrodes, “pencil down” at the end and continue to erode. While some consumption is expected in the melting process, the oxidation loss accelerates the erosion and/or corrosion and reduces the current-carrying capacity of such electrodes. Thus, retardation of the oxidation reactions could be highly beneficial in lowering consumption, both by direct oxidation and by lessening breakage caused by oxidation-induced loss of strength.

In the past, attempts were made to increase the resistance of graphite to burning at high temperatures (above 500° C.) by coating the graphite product with a ceramic protective layer which prevents interaction between graphite (carbon) and oxygen, such as a coating obtained by depositing a film of a material which is supposed to be highly resistant to oxidation at temperatures up to 1000° C. Known ceramic coating systems are Si-based and Zr-based coating systems. However, defects such as cracks and pores are extremely common during the preparation of ceramic coatings. Additionally, some of the ceramic materials, particularly SiO₂, readily crystallizes, leading to the formation of many grain boundaries which would provide pathways for oxygen to attack the substrate.

### SUMMARY

Aspects of the disclosure pertain to methods of protection of carbonaceous surfaces of substrates against erosion and/or oxidation by a protective coating, and the resulting substrates with such protective coating. The substrate may comprise a carbonaceous surface, and may additionally or optionally be comprised of a carbonaceous material below the carbonaceous surface. As used herein, “carbonaceous” means carbon, allotropes of carbon such as graphite, graphitizable (or “hard”) carbon, non-graphitizable carbon, nano-structured carbons such as graphene or fullerenes, or combinations thereof. In embodiments, the protected surface is a surface of a graphite body or a carbon body.

In one aspect, methods are disclosed herein for forming an oxidation protection coating on graphite. In embodiments, the methods comprise applying oxidation inhibitor to a graphite surface via phosphate-borate compound treatment followed by formation of CeO₂—Al₂O₃ coating over the oxidation inhibitor as barrier layer, and then sealing the surface of the barrier layer with phosphate-borate compound, to form an oxygen impermeable layer on the surface of the graphite.

In another aspect, methods are disclosed herein for protecting graphite bodies from oxidation damage, when in an oxidizing environment, by an applied protective coating thereon, and to the process for applying the protective coating to form an impermeable protective barrier for the graphite body. In embodiments, the methods comprise subjecting the surface of a graphite body to phosphate-borate compound treatment followed by the formation of CeO₂—Al₂O₃ coating as barrier layer and then sealing the surface of the barrier layer with phosphate-borate compound.

In another aspect, methods are disclosed herein for protecting a carbonaceous surface of a body, such as surfaces of graphite bodies or carbon bodies, from oxidation in a high-temperature oxidizing environment by a combination of surface modification treatments, wherein the methods of applying surface modification treatments to the surface of graphite or carbon bodies comprise applying a first phosphate-borate compound to the surface (i.e. the support surface for the surface modifications) to reduce oxygen penetration followed by application of a barrier layer to further slow oxygen penetration and then sealing the barrier layer with phosphate-borate compound.

In another aspect, methods are disclosed herein for applying an oxidation resistant protective coating to a carbonaceous surface of a substrate, the methods comprising: applying a phosphate-borate solution to form a first layer to the carbonaceous surface; applying a CeO₂—Al₂O₃ solution onto the first layer to form a second layer; and applying the phosphate-borate solution to an outermost surface portion of the second layer.

In embodiments, the carbonaceous surface is sealed by the first layer. In embodiments, the applying the phosphate-borate solution to the second layer comprises depositing the phosphate-borate solution on and/or in an outermost portion of the second layer.

In embodiments, the phosphate-borate material from the phosphate-borate solution disposed on and/or in the outermost portion of the second layer seals the second layer.

In embodiments, the CeO₂—Al₂O₃ solution is applied as a silica-based sol-gel.

In embodiments, the method further comprises heating the substrate prior to application of the CeO₂—Al₂O₃ solution onto the first layer. In embodiments, the heating is sufficient to dry and cure the phosphate-borate solution to form the first layer.

In embodiments, the method further comprises heating the substrate prior to application of the phosphate-borate solution onto the second layer. In embodiments, the heating is sufficient to dry and cure the CeO₂—Al₂O₃ solution to form the second layer.

In embodiments, the phosphate-borate solution is comprised of phosphoric acid and boric acid. In embodiments, the phosphate-borate solution further comprises aluminum dihydrogen phosphate. In embodiments, the phosphate-borate solution further comprises sodium tetraborate decahydrate. In embodiments, the phosphate-borate solution is aqueous based.

In embodiments, the CeO₂—Al₂O₃ solution is comprised of ceria particles and alumina particles. In embodiments, the CeO₂—Al₂O₃ solution further comprises a cellulosic binder. In embodiments, the cellulosic binder comprises hydroxypropyl cellulose. In embodiments, the CeO₂—Al₂O₃ solution further comprises a silica-based binder. In embodiments, the phosphate-borate solution is alcohol based.

In another aspect, substrates are disclosed herein, the substrates comprising a carbonaceous surface, wherein oxidation resistant protective coating is disposed on the carbonaceous surface, the oxidation resistant protective coating being comprised of a first layer comprised of a phosphate-borate material, a second layer comprised of CeO₂—Al₂O₃, and additional phosphate-borate material disposed on and/or in an outermost surface portion of the second layer.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic representation of a cross-section of a portion of a substrate, such as a graphite body, with its carbonaceous surface upon which a protective coating has been applied.

FIG. 2 schematically represents embodiments of the steps that may be utilized for application of phosphate-borate sealant as disclosed herein.

FIG. 3 schematically illustrates embodiments of barrier coating processing steps as disclosed herein, wherein the next step after application of phosphate-borate above is applying the barrier layer to the phosphate-borate treated substrate.

### DETAILED DESCRIPTION

### Definitions

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to”.

Reference will now be made in detail to embodiments of methods for protecting carbonaceous surfaces against erosion and oxidation by a protective coating thereon. In embodiments, the protective coating forms an oxygen-impermeable protective barrier on the substrate body having a carbonaceous support surface.

In embodiments, to promote adhesion to the support surface and to reduce oxygen penetration, the support surface is first sealed with phosphate-borate compound and then coated over with a barrier coating comprising CeO₂—Al₂O₃ using silica-based sol-gel material as binder. To further enhance the oxygen blocking capability of the barrier layer, the barrier layer is subjected to phosphate-borate treatment to seal cracks and/or pores that may develop during the thermal processing of the barrier coating.

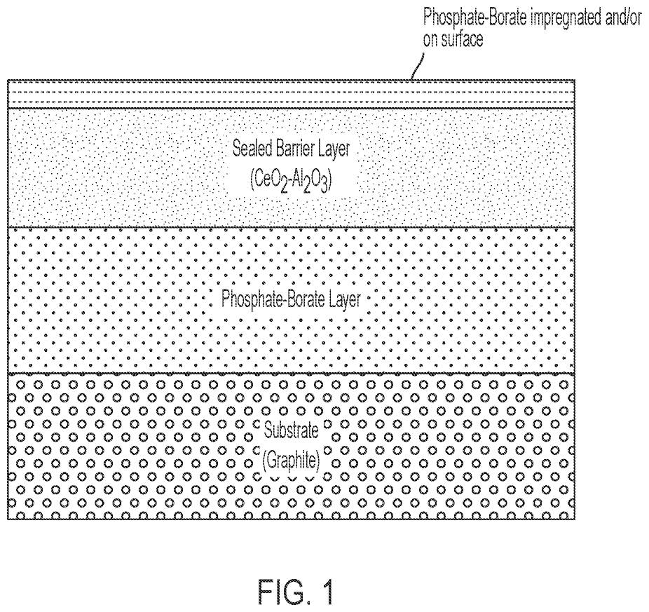

FIG. 1 is a schematic representation of a cross-section of a portion of a substrate, such as a graphite body, with its carbonaceous surface upon which a protective coating has been applied. The protective layer can be referred to as a bi-layer coating, with a first layer of phosphate-borate in contact with the carbonaceous surface, over which a second layer comprising CeO₂—Al₂O₃ covers the first layer, wherein additional phosphate-borate material has been deposited onto and/or impregnated into the outermost surface of the second layer, which need not constitute another layer.

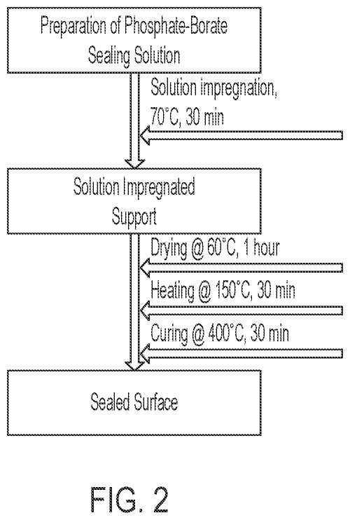

FIG. 2 schematically represents embodiments of the steps that may be utilized for application of phosphate-borate sealant, such as forming a phosphate-borate sealing layer on a carbonaceous surface of a support such as a graphite support. In embodiments, the phosphate-borate sealing layer is prepared as follows: First, the sealing solution is prepared by mixing the precursor materials shown in Table 1 at 70° C. for 30 min. A pre-cleaned graphite support is then immersed in the solution for 30 min. After immersion, the graphite support body specimens are dried in air at 60° C. for 1 hour to remove water, followed by a two-step curing heat treatment at a rate of 5° C./min to 150° C. and holding for 20 min, then heating at a rate of 4° C./min to 400° C. and holding for 30 min.

TABLE 1
Embodiment of phosphate-borate sealing solution

| Reagent | Amount (g) | Wt. % |
|---|---|---|
| Phosphoric acid | 45.55 | 13.67 |
| Boric acid | 6.87 | 2.06 |
| Aluminum dihydrogen phosphate | 63.59 | 19.09 |
| Sodium tetraborate decahydrate | 16.95 | 5.09 |
| DI water | 200.22 | 60.09 |

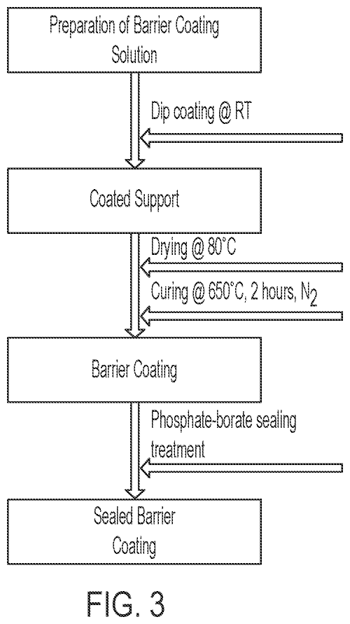

FIG. 3 schematically illustrates embodiments of barrier coating processing steps, wherein the next step after application of phosphate-borate above is applying the barrier layer to the phosphate-borate treated substrate. The coating solution is prepared by mixing the precursor materials in a predetermined proportion as shown in Table 2. The coating is applied to the phosphate-borate treated support by dip coating, followed by drying at 80° C. and then curing at 650° C. for 2 hours in an inert atmosphere such as under N₂. The final step is sealing the surface of the barrier layer with phosphate-borate sealant as described in the first step above.

TABLE 2
Embodiment of barrier layer coating solution for second layer

| Reagent | Amount (g) | Wt. % |
|---|---|---|
| CeO2 | 100 | 8.41 |
| Al2O3 | 30.50 | 2.57 |
| Hydroxypropyl cellulose | 2.96 | 0.25 |
| Silica based binder | 56.12 | 4.72 |
| Ethanol | 999.29 | 84.05 |

### EXAMPLES

Oxidation tests were performed on both coated and uncoated graphite samples to evaluate the oxidation resistant ability of the protective layer as disclosed herein. The coatings were prepared as follows.

The first step was preparation of the phosphate-borate sealing according to the composition shown in Table 1. The phosphate-borate solution was prepared by mixing 45.55 g phosphoric acid, 6.87 g boric acid, 63.59 g aluminum dihydrogen phosphate, 16.95 g sodium tetraborate decahydrate and 200.22 g DIW at 70° C. for 3 hours to ensure complete dissolution. The next steps were the general cleaning of the support and application of the surface modification treatments which proceeded as follows: for each graphite coupon, Mersen 2020 grade was initially cleaned by sonicating for 10 min each in acetone and ethanol and dried in an oven at 60° C. for 1 h. Next step was application of phosphate-borate sealing solution. The cleaned graphite coupon to be coated was immersed in the sealing solution for 30 min to impregnate the surface pores. After immersion, the graphite coupon was dried in air at 60° C. for 1 hour to remove water. It was followed by a two-step curing heat treatment at a rate of 5° C./min to 150° C. and holding for 20 min, then heating at a rate of 4° C./min to 400° C. and holding for 30 min.

The next step was application of the barrier layer. The barrier coating solution was prepared by mixing 100 g CeO₂, 30.5 g Al₂O₃, 2.96 g hydroxypropyl cellulose, 56.12 g binder, and 999.26 g ethanol. The mixture solution was ball milled for about 3 hours. After ball milling, the phosphate-borate treated coupon was dipped in the coating for 30 seconds followed by drying at 80° C. and curing at 650° C. for 2 hours under flowing N₂. The final step was application of the phosphate-borate treatment to the barrier layer to seal the cracks and pores developed during the thermal processing of the barrier layer.

To evaluate the oxidation resistance of the coated graphite coupon, the coated coupon was subjected to oxidation tests. The oxidation tests were carried out in air at 800° C. cooled rapidly to room temperature. The oxidation test results are presented in Table 3 which shows that the average weight loss of the coated sample was less than 0.5% compared to that of the uncoated sample which was about 8%.

TABLE 3

| | | Initial | Final weight- | |
|---|---|---|---|---|
| | Sample | Weight | After heat | Weight |
| Sample ID | Description | (g) | treatment (g) | Loss (%) |
| Uncoated | Uncoated graphite | 7.83 | 7.21 | 7.9 |
| Example 1 | coupon | | | |
| Uncoated | | 7.8 | 7.17 | 8.1 |
| Example 2 | | | | |
| Uncoated | | 7.72 | 7.12 | 7.8 |
| Example 3 | | | | |
| Coated | Graphite coupon | 7.79 | 7.76 | 0.39 |
| Example 1 | with protective | | | |
| Coated | coating | 7.65 | 7.63 | 0.26 |
| Example 2 | | | | |
| Coated | | 7.91 | 7.88 | 0.38 |
| Example 3 | | | | |

Thus, embodiments disclosed herein can help protect bodies with carbonaceous surfaces, such as graphite bodies, from oxidation in high-temperature oxidizing environments. Heat resistance and/or ablation resistance of such bodies (such as graphite bodies) can be improved. For example, the graphite body may have high thermal stability and oxidation resistance when exposed to air. In embodiments, the protective coating can be applied using coating techniques such as dip, or spray, on large or small shaped structures, and may help reduce costs by lowering energy consumption, and with a reduced need for complex processing equipment. Embodiments of the protective coating and related methods disclosed herein can avoid the use of Zr-based coating.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed:

1. A method for applying an oxidation resistant protective coating to a carbonaceous surface of a substrate, the method comprising:
applying a phosphate-borate solution to form a first layer on the carbonaceous surface;
applying a CeO₂—Al₂O₃ solution onto the first layer to form a second layer; and
applying the phosphate-borate solution to an outermost surface portion of the second layer.

2. The method of claim 1 wherein the carbonaceous surface is sealed by the first layer.

3. The method of claim 1 wherein the applying the phosphate-borate solution to the second layer comprises depositing the phosphate-borate solution on and/or in an outermost portion of the second layer.

4. The method of claim 3 wherein the phosphate-borate material from the phosphate-borate solution disposed on and/or in the outermost portion of the second layer seals the second layer.

5. The method of claim 1 wherein the CeO₂—Al₂O₃ solution is applied as a silica-based sol-gel.

6. The method of claim 1 wherein the method further comprises heating the substrate prior to application of the CeO₂—Al₂O₃ solution onto the first layer.

7. The method of claim 6 wherein the heating is sufficient to dry and cure the phosphate-borate solution to form the first layer.

8. The method of claim 1 wherein the method further comprises heating the substrate prior to application of the phosphate-borate solution onto the second layer.

9. The method of claim 8 wherein the heating is sufficient to dry and cure the CeO₂—Al₂O₃ solution to form the second layer.

10. The method of claim 1 wherein the phosphate-borate solution is comprised of phosphoric acid and boric acid.

11. The method of claim 10 wherein the phosphate-borate solution further comprises aluminum dihydrogen phosphate.

12. The method of claim 11 wherein the phosphate-borate solution further comprises sodium tetraborate decahydrate.

13. The method of claim 12 wherein the phosphate-borate solution is aqueous based.

14. The method of claim 1 wherein the CeO₂—Al₂O₃ solution is comprised of ceria particles and alumina particles.

15. The method of claim 14 wherein the CeO₂—Al₂O₃ solution further comprises a cellulosic binder.

16. The method of claim 15 wherein the cellulosic binder comprises hydroxypropyl cellulose.

17. The method of claim 14 wherein the CeO₂—Al₂O₃ solution further comprises a silica based binder.

18. The method of claim 17 wherein the phosphate-borate solution is alcohol based.

19. A substrate comprising a carbonaceous surface, wherein oxidation resistant protective coating is disposed on the carbonaceous surface, the oxidation resistant protective coating being comprised of a first layer comprised of a phosphate-borate material, a second layer comprised of CeO₂—Al₂O₃, and additional phosphate-borate material disposed on and/or in an outermost surface portion of the second layer.

20. The substrate of claim 19 wherein the carbonaceous surface comprises graphite.
